(19) United States
(12) Patent Application Publication
(10) Pub. No.: US 2023/0093497 A1
(43) Pub. Date: Mar. 23, 2023

(54) LENS GROUP, CAMERA MODULE, AND TERMINAL DEVICE

(71) Applicant: HUAWEI TECHNOLOGIES CO., LTD., Shenzhen (CN)

(72) Inventors: Haishui YE, Shanghai (CN); Hong GE, Shanghai (CN)

(73) Assignee: HUAWEI TECHNOLOGIES CO., LTD., Shenzhen (CN)

(21) Appl. No.: 17/794,538

(22) PCT Filed: Jan. 18, 2021
(86) PCT No.: PCT/CN2021/072565

§ 371 Date: Jul. 21, 2022

(30) Foreign Application Priority Data
Jan. 22, 2020 (CN) 202010076737.7

(51) Int. Cl. G02B 9/34; H04N 5/225; G03B 30/00; G02B 13/00

(52) U.S. Cl. CPC G02B 9/34; H04N 5/2254; G03B 30/00; G02B 13/0045; H04M 1/0264

(57) ABSTRACT

Embodiments of this application provide a lens group, a camera module, and a terminal device. The lens group includes a first group, a second group, a third group, and a fourth group that are sequentially disposed from an object side to an image side along an optical axis of the lens group. The second group includes a doublet formed by gluing a second lens and a third lens together. The optical power of a lens in each group is designed to match the optical power of the doublet so that a compact high-quality long-focus lens group can be implemented and chromatic aberration may be eliminated.

### CROSS-REFERENCE TO RELATED APPLICATION

This application is a national stage of International Application No. PCT/CN2021/072565, filed on Jan. 18, 2021, which claims priority to Chinese Patent Application No. 202010076737.7 filed on Jan. 22, 2020. Both of the aforementioned applications are hereby incorporated by reference in their entireties.

### TECHNICAL FIELD

This application relates to the field of optical imaging technologies, and in particular, to a lens group, a camera module, and a terminal device.

### BACKGROUND

In recent years, with development of terminal device technologies, a photographing function has become a regularly utilized function of many intelligent terminal devices (such as a smartphone), and a lens group became one of the regularly utilized components in the terminal device. In a multi-camera combined zoom system, a long-focus lens group design is a regularly utilized component. In an existing multi-camera combined zoom system, a temperature effect (also referred to as a temperature drift phenomenon) and a chromatic aberration of a long-focus lens group may result in relatively severe effects, and a quality of a modulation transfer function (MTF) may also be affected.

Therefore, a long-focus lens group with high imaging quality is needed to meet a market demand.

### SUMMARY

This application provides a lens group, a camera module, and a terminal device, to resolve the problem in the conventional technology.

To achieve the foregoing objectives, the following technical solutions are used in embodiments of this application.

According to a first aspect, an embodiment of this application provides a lens group, including a first group, a second group, a third group, and a fourth group that are sequentially disposed from an object side to an image side along an optical axis. The first group has positive optical power. The second group has positive optical power, the second group includes a second lens and a third lens that are sequentially disposed from the object side to the image side along the optical axis, and the second lens and the third lens are bonded as a doublet. The third group has negative optical power. An optical length of the lens group is Through-The-Lens (TTL) metering, an effective focal length of the lens group is f, and TTL and f meet: TTL/f≤1. In the lens group, optical power of lenses is matched with the doublet, and TTL and f are properly limited, so that a total length of the lens group (or a cylinder length of the lens group) can be reduced, and a back focal length can be maximized. In addition, miniaturization and a long focal length of the lens group can be ensured, and a chromatic aberration can be eliminated. Along focal length of at least 5× can be implemented by using only the four groups, so that a thickness of a camera module can be smaller.

For example, dispersion coefficients of the second lens and the third lens are respectively V2 and V3, V2 meets: 15≤V2≤100, and V3 meets: 15≤V3≤100. The dispersion coefficients V2 and V3 are properly limited, and optical power is properly allocated, so that a chromatic aberration can be effectively corrected.

For example, the fourth group is a fifth lens, a curvature radius of an object side surface of the fifth lens is R51, a curvature radius of an image side surface of the fifth lens is R52, and R51 and R52 meet: |f/R51|+|f/R52|≤8. f, R51, and R52 are properly limited, so that the curvature radiuses of the two side surfaces of the fifth lens can be adjusted to proper values, to correct an off-axis aberration and a comprehensive aberration, and ensure an overall assembly process of the lens group.

For example, a combined focal length of the second lens and the third lens is f23, and f23 meets: 0≤f23/f≤3. f and f23 are properly limited, and optical power, a dispersion coefficient, and a refractive index temperature coefficient are properly allocated, so that a chromatic aberration can be effectively corrected, and a temperature effect can be reduced.

According to a second aspect, an embodiment of this application provides a camera module, including an image sensor. The camera module further includes the lens group in the first aspect, and the image sensor is located on an image side of the lens group. The lens group is disposed in the camera module, so that a lens group length of the camera module can be shortened, and a camera module with a long focal length, a small size, temperature insensitivity, and high imaging quality can be implemented on a premise of ensuring that the camera module is relatively thin.

According to a third aspect, an embodiment of this application provides a terminal device, including the camera module in the second aspect. The camera module with the lens group is disposed in the terminal device, so that various photographing application scenarios of a higher focal length multiple (especially, a long focal length of at least 5×) can be implemented, thereby improving photographing quality; and a thickness of the terminal device can be effectively reduced, thereby enhancing a function of the terminal device, and improving user experience.

According to a fourth aspect, an embodiment of this application provides a mobile phone, including a housing, a display, a speaker, a microphone, and one or more camera modules in the second aspect, where at least one lens group is located on a surface on which the display is located, or/and at least one lens group is located on a surface that faces away from the display. The camera module with the lens group is disposed in the mobile phone, so that various photographing application scenarios of a higher focal length multiple (especially, a long focal length of at least 5×) can be implemented, thereby improving photographing quality; and a thickness of the mobile phone can be effectively reduced, thereby enhancing a function of the terminal device, and improving user experience. This solution is applicable to a smart household, an intelligent vehicle-mounted device, an intelligent wearable device, a smartphone, an artificial intelligence field device, and the like.

### BRIEF DESCRIPTION OF DRAWINGS

FIG. 1 is a schematic diagram of a structure of a lens group according to some embodiments of this application;

FIG. 2 is a schematic simulation diagram of a spherical aberration of a lens group according to the embodiment shown in FIG. 1 of this application;

FIG. 3 is a schematic simulation diagram of a field curve of a lens group according to the embodiment shown in FIG. 1 of this application;

FIG. 4 is a schematic simulation diagram of distortion of a lens group according to the embodiment shown in FIG. 1 of this application;

FIG. 5 is a schematic diagram of an off-axis chromatic aberration of a lens group according to the embodiment shown in FIG. 1 of this application;

FIG. 6 is a schematic diagram in which a beam converges on an image sensor after passing through a lens group according to the embodiment shown in FIG. 1 of this application;

FIG. 7 is a schematic diagram of a structure of a lens group according to some embodiments of this application;

FIG. 8 is a schematic simulation diagram of a spherical aberration of a lens group according to the embodiment shown in FIG. 7 of this application;

FIG. 9 is a schematic simulation diagram of a field curve of a lens group according to the embodiment shown in FIG. 7 of this application;

FIG. 10 is a schematic simulation diagram of distortion of a lens group according to the embodiment shown in FIG. 7 of this application;

FIG. 11 is a schematic diagram of an off-axis chromatic aberration of a lens group according to the embodiment shown in FIG. 7 of this application;

FIG. 12 is a schematic diagram in which a beam converges on an image sensor after passing through a lens group according to the embodiment shown in FIG. 7 of this application;

FIG. 13 is a schematic diagram of a structure of a lens group according to some embodiments of this application;

FIG. 14 is a schematic simulation diagram of a spherical aberration of a lens group according to the embodiment shown in FIG. 13 of this application;

FIG. 15 is a schematic simulation diagram of a field curve of a lens group according to the embodiment shown in FIG. 13 of this application;

FIG. 16 is a schematic simulation diagram of distortion of a lens group according to the embodiment shown in FIG. 13 of this application;

FIG. 17 is a schematic diagram of an off-axis chromatic aberration of a lens group according to the embodiment shown in FIG. 13 of this application;

FIG. 18 is a schematic diagram in which a beam converges on an image sensor after passing through a lens group according to the embodiment shown in FIG. 13 of this application; and

FIG. 19A and FIG. 19B are schematic diagrams of a mobile phone according to some embodiments of this application.

### REFERENCE SIGNS

OA—optical axis;
ST—stop;
GT—first group;
G2—second group;
G3—third group;
G4—fourth group;
L1—first lens;
L2—second lens;
L3—third lens;
L4—fourth lens;
L5—fifth lens;
12—light filter (may be an infrared cut-off filter);
13—image sensor;
S1—object side surface of the first lens L1, namely, surface that is of the first lens and that faces an object side;
S2—image side surface of the first lens L1, namely, surface that is of the first lens and that faces an image side;
S3—object side surface of the second lens L2, namely, surface that is of the second lens and that faces the object side;
S4—bonding surface of the second lens L2 and the third lens L3;
S5—image side surface of the third lens L3, namely, surface that is of the third lens and that faces the image side;
S6—object side surface of the fourth lens L4, namely, surface that is of the fourth lens and that faces the object side;
S7—image side surface of the fourth lens L4, namely, surface that is of the fourth lens and that faces the image side;
S8—object side surface of the fifth lens L5, namely, surface that is of the fifth lens and that faces the object side;
S9—image side surface of the fifth lens L5, namely, surface that is of the fifth lens and that faces the image side;
S10—object side surface of the light filter 12, namely, surface that is of the light filter and that faces the object side;
S11—image side surface of the light filter 12, namely, surface that is of the light filter and that faces the image side; and
S12—image surface, namely, surface on which an image sensor is located.

### DESCRIPTION OF EMBODIMENTS

Terms used in embodiments of this application are only used to explain specific embodiments of this application, but are not intended to limit this application.

It should be clear that the described embodiments are merely some rather than all of the embodiments of this application. All other embodiments obtained by a person of ordinary skill in the art based on embodiments of this application without creative efforts shall fall within the protection scope of this application.

The terms used in embodiments of this application are merely for the purpose of illustrating specific embodiments, and are not intended to limit the present disclosure. The terms “a”, “said” and “the” of singular forms used in embodiments and the appended claims of this application are also intended to include plural forms, unless otherwise specified in the context clearly.

It should be noted that the orientation words, such as “on”, “under”, “left”, and “right”, described in the embodiments of this application are described from angles shown in the accompanying drawings, and should not be construed as a limitation on the embodiments of this application. In addition, in the context, it should be further understood that, when one component is connected “on” or “under” another component, the component can be directly connected “on” or “under” the another component, or may be indirectly connected “on” or “under” the another component by using an intermediate component.

A lens group of a terminal device is designed by using a 4- to 7-lens structure, so that a long focal length can be implemented. As a designed focal length of a lens group is increased, a temperature effect may be more obvious, which may severely affect user experience.

As one solution, temperature compensation is performed on a terminal device by monitoring an ambient temperature of a lens group, calculating a step of a voice coil motor (VCM) where the voice coil motor can adjust a position of a lens to change a focal length, and the lens is pushed to perform focusing. In this solution, the VCM may require defining a larger stroke. Consequently, power consumption and design difficulty of the VCM are increased, and a non-linear area of the VCM is easily entered. In addition, in the temperature compensation method, computing power of an image signal processor (ISP) may need to be increased, and precision of the temperature compensation algorithm of the terminal device may be limited. Therefore, it is difficult to perform real-time compensation based on a complex temperature scenario. In addition, a chromatic aberration of a long-focus lens group is relatively severe, affecting an imaging effect of a camera module.

As a focal length of the lens group is increased, a temperature effect is more obvious, and a chromatic aberration requirement may become more stringent. Therefore, it has become a recognized problem in the industry to resolve both a temperature effect problem and a chromatic aberration problem while a long-focus requirement is met.

To resolve the foregoing problem, the embodiments of this application provide a lens group, a camera module, and an electronic device. The following describes the embodiments of this application with reference to the accompanying drawings in the embodiments of this application.

The embodiments of this application relate to the lens group, the camera module, and the electronic device. The lens group is a long-focus lens group used in commonly used electronic devices. For example, an equivalent f-number is greater than or equal to 5×, and an equivalent focal length is greater than or equal to 125 mm. The equivalent focal length (EFL) means that lens group focal lengths of different frames are equivalent to a 35 mm full-frame lens group focal length, and has an equal-proportional relationship. Equivalent focal length=43.3×actual focal length/diagonal length of a target surface of an image sensor. The electronic device may be a mobile phone, a notebook computer, a desktop computer, a tablet computer, a personal digital assistant (PDA), a wearable device, an augmented reality (AR) device, a virtual reality (VR) device, a monitoring device, a vehicle-mounted device, or a smart household.

The following briefly describes the concepts in the foregoing embodiments.

Lens group: The lens group is a component that uses a lens refraction principle to enable light rays of a scene to pass through the lens group to form a clear image on a focusing plane.

Aberration: The aberration is a deviation with an ideal status of Gaussian optics (a first-order approximation theory or a paraxial light ray) due to inconsistency between a result obtained by tracing a non-paraxial light ray and a result obtained by tracing a paraxial light ray in a lens group. Aberrations are further classified into two types: a chromatic aberration and a monochromatic aberration. The chromatic aberration means that a refractive index of a material of a lens is a function of a wavelength, and therefore a dispersion phenomenon is caused due to different refractive indexes when light of different wavelengths passes through the lens. Dispersion in which a refractive index of light decreases as a wavelength increases may be referred to as normal dispersion, and dispersion in which a refractive index increases as a wavelength increases may be referred to as negative dispersion (or abnormal dispersion). The monochromatic aberration is an aberration caused even under highly monochromatic light. Based on caused effects, monochromatic aberrations are further classified into two types: “making an image blur” and “making an image deform”. The former includes a spherical aberration, astigmatism, and the like, and the latter includes an image field curve, distortion, and the like. The chromatic aberration includes an axial chromatic aberration and an off-axis chromatic aberration. The axial chromatic aberration means that in an optical axis direction, a lens has different refractive indexes for light of different wavelengths, and therefore focal points of light of different colors are different.

Optical power: The optical power is equal to a difference between an image-side beam convergence degree and an object-side beam convergence degree, and represents a light ray deflection capability of a lens group. If the optical power is positive, the lens has a convergence action; or if the optical power is negative, the lens has a divergence action.

Focal length: The focal length is a distance from a main plane of a lens group to a corresponding focal point.

Aperture stop: A stop with a smallest incidence aperture angle is referred to as the aperture stop.

Object side: A side that is of a lens and that is closest to a real object is the object side.

Image side: A side that is of a lens and that is closest to an imaging side is the image side.

Temperature effect: The temperature effect is also referred to as a temperature drift phenomenon, and means that a surface shape, a size, a refractive index of a lens vary as a temperature increases. A focal length and a back focal length of a lens group change with a temperature. This is referred to as a temperature effect.

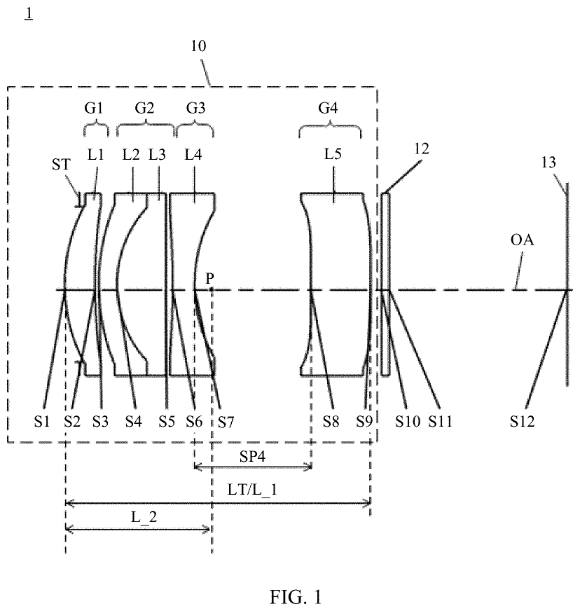

As shown in FIG. 1, the lens group provided in the embodiments of this application is described now according to some embodiments of the present application. FIG. 1 is a cross-sectional view of a lens group in an optical axis direction. In FIG. 1, for clear display, an object surface is not shown. The lens group is disposed between the image sensor and the object surface, to form an image of a real object and reflect the image to the image sensor. Therefore, a side on which the real object is located may be referred to as an object side, a side on which the image sensor is located is referred to as an image side, and a surface on which the image sensor is located may be referred to as an image surface. A lens group 10, a light filter 12, and an image sensor 13 may jointly form a camera module 1. The lens group 10 includes a stop (also referred to as an aperture stop) ST, a first group G1, a second group G2, a third group G3, and a fourth group G4 that are sequentially disposed from an object side to an image side along an optical axis OA. The first group G1 has positive optical power. The second group G2 has positive optical power, the second group G2 includes a second lens L2 and a third lens L3 that are sequentially disposed from the object side to the image side along the optical axis, and the second lens L2 and the third lens L3 are bonded as a doublet. The third group has negative optical power. Optical power of the first group G1 to the fourth group G4 is designed in matching with the doublet, so that a high-quality long-focus lens group that can implement a compact long-focus lens group and chromatic aberration elimination can be designed.

Specifically, the first group G1 has the positive optical power; and focuses a beam and deflects a large-angle light ray, so that a total length of the lens group 10 can be shortened, thereby facilitating miniaturization of the lens group. In a specific embodiment, two side surface shapes of the first group G1 are consistent in direction (for example, when an object side surface S1 of the first group G1 is a convex surface at a paraxial position, an image side surface S2 of the first group G1 is a concave surface at a paraxial position; or when an object side surface S1 of the first group G1 is a concave surface at a paraxial position, an image side surface S2 of the first group G1 is a convex surface at a paraxial position), and angles of view are slightly scattered, thereby facilitating optimization of an aberration of the lens group.

The second group G2 has the positive optical power, and further focuses a beam obtained after the first group G1 performs focusing, so that the total length of the lens group 10 can be further shortened, thereby facilitating miniaturization of the lens group. The second group G2 includes the second lens L2 and the third lens L3, and the second lens L2 and the third lens L3 are bonded as the doublet. The second lens L2 and the third lens L3 may be respectively made of materials with different refractive indexes and dispersion coefficients, to eliminate a chromatic aberration, thereby improving imaging quality. In some embodiments, the second lens L2 and the third lens L3 may be bonded by using an adhesive. The adhesive may be a material such as Canadian fir balsam or epoxy. In addition, in some other embodiments, the second lens L2 and the third lens L3 may be bonded without using an adhesive, and the second lens L2 and the third lens L3 are bonded together by using an external fixture.

The third group has the negative optical power to diffuse a beam, thereby helping implement a long focal length of a high multiple and balance optical aberrations at different apertures.

An effective focal length of the lens group 10 is f, and a distance (also referred to as an optical length of the lens group 10) from the object side surface S1 of the first group G1 to an imaging surface of an object at infinity on the optical axis is TTL (Through the Lens). TTL and f meet: TTL/f≤1. TTL/f≤1 is properly limited, so that a size of the entire lens group 10 is reduced on a premise of ensuring a long focal length. If a value of TTL/f≤1 is too large, an overall size of the camera module may be too large.

In the lens group 10 in this embodiment of this application, optical power of lenses is matched with the doublet, so that the total length of the lens group (or a cylinder length of the lens group) can be reduced, and a back focal length can be maximized. In addition, miniaturization and a long focal length of the lens group can be ensured, and a chromatic aberration can be eliminated. A long focal length of at least 5× can be implemented by using only the four groups, so that a thickness of the camera module 1 can be smaller.

In some embodiments, an object side surface S1 of a first lens L1 is a convex surface at a paraxial position, and the first group G1 has the positive optical power, so that a beam can be better focused, and the total length of the lens group 10 can be shortened, thereby facilitating miniaturization of the lens group.

In some embodiments, dispersion coefficients (Abbe numbers) of the second lens L2 and the third lens L3 are respectively V2 and V3, V2 meets: 15≤V2≤100, and V3 meets: 15≤V3≤100. The dispersion coefficients V2 and V3 are properly limited, and optical power is properly allocated, so that a chromatic aberration can be effectively corrected. In some embodiments, compensation design is performed on the dispersion coefficients of the second lens L2 and the third lens L3, to better reduce a comprehensive chromatic aberration of the lens group, thereby achieving a better imaging effect. For example, if the dispersion coefficient V2 of the second lens L2 meets: 15≤V2≤40, and the dispersion coefficient V3 of the third lens L3 meets: 40≤V3≤100, the dispersion coefficients of the second lens L2 and the third lens L3 can be effectively compensated for. Alternatively, if the dispersion coefficient V2 of the second lens L2 meets: 40≤V2≤100, and the dispersion coefficient V3 of the third lens L3 meets: 15≤V3≤40, the dispersion coefficients of the second lens L2 and the third lens L3 can also be effectively compensated for.

It should be noted that the dispersion coefficient is an index used to indicate a dispersion capability of a transparent medium. Generally, a larger refractive index of the medium indicates more severe dispersion and a smaller dispersion coefficient. Conversely, a smaller refractive index of the medium indicates slighter dispersion and a larger dispersion coefficient. A calculation formula of the dispersion coefficient is V=(n−1)/(nf−nc), where n is a refractive index of light of a 587 nm wavelength, nf is a refractive index of f light (light of a 486 nm wavelength), and nc is a refractive index of c light (light of a 656 nm wavelength).

In some embodiments, a combined focal length of the second lens L2 and the third lens L3 is f23, and f23 meets: 0≤f23/f≤3. f and f23 are properly limited, and optical power, a dispersion coefficient, and a refractive index temperature coefficient are properly allocated, so that a chromatic aberration can be effectively corrected, and a temperature effect can be reduced. If f23/f is too large, achromatic aberration correction capability is relatively poor, and it is unhelpful to reduce a temperature effect.

In some embodiments, a bonding surface S4 of the second lens L2 and the third lens L3 is a spherical surface, so that a chromatic aberration can be effectively corrected, and manufacturing difficulty of the doublet can be reduced. A curvature radius of the bonding surface S4 is R23, and R23 meets: 0 mm≤R23≤10 mm. R23 is properly limited, so that the curvature radius R23 of the bonding surface S4 can be adjusted to a proper value, to correct a chromatic aberration and reduce manufacturing difficulty of the doublet.

In some embodiments, the fourth group G4 is a fifth lens L5, a curvature radius of an object side surface S8 of the fifth lens L5 is R51, a curvature radius of an image side surface S9 of the fifth lens L5 is R52, and R51 and R52 meet: |f/R51|+|f/R52|≤8. f, R51, and R52 are properly limited, so that the curvature radiuses of the two side surfaces of the fifth lens L5 can be adjusted to proper values, to correct an off-axis aberration and a comprehensive aberration, and ensure an overall assembly process of the lens group 10. If |f/R51|+|f/R52| may be too large, a capability of correcting the off-axis aberration and the comprehensive aberration may be relatively poor.

In some embodiments, as shown in FIG. 1, a spacing from a center position of an image side surface of the third group G3 to a center position of an object side surface of the fourth group G4 is SP4, a spacing from a center position of the object side surface of the first group G1 to a center position of an image side surface of the fourth group G4 is LT, and SP4 and LT meet: SP4/LT≤0.3. SP4 and LT are properly limited, so that the curvature radiuses of the two side surfaces of the fifth lens L5 can be adjusted to proper values, to correct an off-axis aberration and a comprehensive aberration and ensure an overall assembly process of the lens group 10. If |f/R51|+|f/R52| is too large, a capability of correcting the off-axis aberration and the comprehensive aberration is relatively poor. For example, in FIG. 1, when the first group G1 is the first lens L1, the third group G3 is the fourth lens L4, and the fourth group G4 is the fifth lens L5, SP4 is a spacing from a center position of an image side surface S7 of the fourth lens L4 to a center position of the object side surface S8 of the fifth lens L5, and LT is a spacing from the center position of the object side surface S1 of the first lens L1 to a center position of the image side surface S9 of the fifth lens L5.

In some embodiments, a length of the lens group 10 is L_1, a length from a center P of gravity of the lens group 10 to a vertex position of the image side surface of the first group G1 is L_2, and L_1 and L_2 meet: 0.4×L_1≤L_2≤0.6×L_1. L_1 and L_2 are properly limited, so that the center of gravity P of the lens group 10 can be near the center of the length of the lens group 10. Therefore, titling of a motor can be prevented to effectively prevent shaking, and an aberration can be optimized. Materials and thicknesses of the groups may be properly allocated, so that the center P of gravity of the lens group 10 is disposed at a proper position. For example, when the second lens L2 and the third lens L3 are made of glass, and the first group G1, the third group G3, and the fourth group G4 are made of plastic (or resin), because a density of glass is greater than a density of plastic, a thickness of the fourth group G4 may be appropriately increased, to prevent the center P of gravity of the lens group 10 from being too close to the front (a direction towards the object side is the front). In FIG. 1, when the first group G1 is the first lens L1, the third group G3 is the fourth lens L4, and the fourth group G4 is the fifth lens L5; the object side surface S1 of the first lens L1 is a convex surface, and the vertex position of the object side surface of the first group G1 is the center position of the object side surface S1; and the image side surface S9 of the fifth lens L5 is a convex surface, and a vertex position of the image side surface of the fourth group G4 is the center position of the image side surface S9, the length L_1 of the lens group 10 indicates a same length as LT. If the object side surface S1 of the first lens L1 is a concave surface, the vertex position of the object side surface of the first group G1 is an edge position of the object side surface S1. If the image side surface S9 of the fifth lens L5 is a concave surface, a vertex position of the image side surface of the fourth group G4 is an edge position of the image side surface S9.

In some embodiments, when the first group G1 is the first lens L1, the third group G3 is the fourth lens L4, and the fourth group G4 is the fifth lens L5, a material of at least one of the first lens L1, the second lens L2, the third lens L3, the fourth lens L4, and the fifth lens L5 is made of glass. A refractive index temperature coefficient of glass is less than a refractive index temperature coefficient of plastic (the refractive index temperature coefficient of plastic is about 10 to 100 times the refractive index temperature coefficient of glass). Therefore, a lens made of glass can effectively compensate for a temperature effect. In addition, dispersion of the lens made of glass is relatively low, to help reduce dispersion. A relative refractive index temperature coefficient β (may also be represented as (dn/dt)rel) indicates a change coefficient, of a refractive index of a material in a medium such as air, with a temperature. In some embodiments, a relative refractive index temperature coefficient β of glass meets: −9×10⁻⁵≤β≤9×10⁻⁵. The refractive index temperature coefficient β is properly limited, and optical power is allocated, so that a temperature effect in the module 1 can be effectively eliminated. It should be noted that, during specific implementation, the other lenses of the lens group may be all made of resin such as plastic. The plastic material has low costs, and is easy to be processed, thereby reducing material costs and processing costs of the entire lens group. The lens group formed by mixing and matching glass and resin can have a characteristic that a refractive index of the glass material is insensitive to a temperature coefficient, and can effectively reduce material costs and processing costs of the entire lens group. In some embodiments, the second lens L2 and the third lens L3 are made of glass, that is, two lenses of the doublet are both glass. The dispersion coefficients of the second lens L2 and the third lens L3 are matched, so that a chromatic aberration can be better weakened while a temperature effect is compensated for.

In some embodiments, the lens group 10 further includes an aperture stop ST, and the aperture stop ST may be a vignetting stop. The aperture stop ST is used to define a width of a beam incident from the object side, to limit an imaging range of the lens group 10, thereby helping reduce an outer diameter of the lens group 10. In FIG. 1, the aperture stop ST is located on a side that is of the first group G1 and that faces the image side. In some embodiments, the aperture stop ST may be located on a side that is of the first group G1 and that faces the object side.

In the lens group 10, at least a part of surfaces of the first lens L1 to the fifth lens L5 are aspherical surfaces, to help correct an aberration, and also help correct a peripheral aberration of an image, thereby improving imaging quality of the lens group.

An aspherical curve equation of the lenses is represented as follows:

$$Z = \frac{c {r}^{2}}{1 + \sqrt{1 - ( 1 + k ) {c}^{2} {r}^{2}}} + {\sum }_{i = 2}^{n} {A}_{2 i} {r}^{2 i}$$

Z is a vector height parallel to a z-axis, r is a vertical distance between a point on an aspherical curve and the optical axis, c is a curvature at a vertex at which an aspherical surface intersects the optical axis, k is a conic coefficient, Ai is an i^{th}-order aspherical coefficient, and n is a total quantity of polynomial coefficients in a series.

Shapes, thicknesses, optical power, and materials of the lenses are properly configured, so that a temperature drift coefficient Δf/Δ° C. (a change rate of the effective focal length f with a temperature) of the lens group 10 meets: −0.5 μm/° C.≤Δf/Δ° C.≤1.5 μm/° C. The temperature drift coefficient Δf/Δ° C. is properly limited, so that a temperature effect of the lens group 10 can be effectively suppressed.

It should be further noted that the lenses in this specification are all optical elements that are disposed on the optical axis and that have optical power. For a surface shape of the lens, the “convex surface” and the “concave surface” both indicate paraxial shapes. That is, the foregoing surface shapes all indicate a shape of a part that has substantial impact on a light ray. However, an edge shape of the lens is not strictly limited. An object side surface and an image side surface of the lens may be parallel, thereby facilitating processing.

It can be seen that the lens group provided in the embodiments of this application may include the stop ST, the first group G1, the second group G2, the third group G3, and the fourth group G4 that are sequentially disposed from the object side to the image side along the optical axis. The first group G1 has the positive optical power. The second group G2 has the positive optical power, the second group G2 includes the second lens L2 and the third lens L3 that are sequentially disposed from the object side to the image side along the optical axis, and the second lens L2 and the third lens L3 are bonded as the doublet. The third group has the negative optical power. In the lens group 10 in these embodiments of this application, a glass-plastic mixed lens group structure is used, and materials, shapes, thicknesses, chromatic aberration coefficients, optical power, and the like of the groups are properly allocated, so that dispersion of the lens group can be reduced, and a temperature effect of a long-focus photographing lens group can be effectively improved. An MTF and a focal length of the lens group are insensitive to a temperature. In addition, light rays of different wavelengths can be focused on one image surface after passing through the lens group 10, thereby improving imaging performance, and also making the long-focus lens group more compact. A long focal length can be implemented by using only a limited quantity of groups (or lenses), so that a thickness of the module 1 can be less than 68 mm. An off-axis chromatic aberration CA1 of the lens group 10 may be made less than or equal to 1 μm, and an axial chromatic aberration CA2 of the lens group 10 may be made less than or equal to 10 μm, so that an imaging effect is good.

Based on the structural framework of the foregoing lens group, the following describes in detail some implementations of the lens group provided in the embodiments of this application.

### Embodiment 1

Refer to FIG. 1. In these embodiments, a lens group 10 may include an aperture stop ST, a first group G1, a second group G2, a third group G3, and a fourth group G4 that are sequentially disposed from an object side to an image side along an optical axis OA. The first group G1 includes a first lens L1. The second group G2 includes a doublet including a second lens L2 and a third lens L3. The third group G3 includes a fourth lens L4. The fourth group G4 includes a fifth lens L5. The aperture stop ST, the first lens L1, the second lens L2, the third lens L3, the fourth lens L4, and the fifth lens L5 jointly constitute the lens group 10 in these embodiments of this application. The lens group 10, a light filter 12, and an image sensor 13 that are sequentially arranged from the object side to the image side along the optical axis constitute a camera module 1.

The first group G1 has positive optical power. The first group G1 includes the first lens L1, the first lens L1 has the positive optical power, an object side surface S1 of the first lens L1 is a convex surface at a paraxial position, an image side surface S2 of the first lens L1 is a concave surface at a paraxial position, and the object side surface S1 and the image side surface S2 are both aspherical surfaces. A beam entering from the aperture stop 10 is focused by using the first lens L1, so that a total length of the lens group can be shortened, thereby facilitating miniaturization of the lens group. The object side surface S1 and the image side surface S2 are both aspherical surfaces, to help correct an aberration. The first lens L1 is made of resin, to help reduce costs. A distance (also referred to as an optical length of the lens group 10) from the object side surface S1 of the first group G1 to an imaging surface of an object at infinity on the optical axis is TTL, and TTL/f≤0.95, to help implement relatively short TTL.

The second group G2 has positive optical power. The second group G2 includes the second lens L2 and the third lens L3, and the second lens L2 and the third lens L3 are bonded as the doublet to eliminate a chromatic aberration. An object side surface S3 of the second lens L2 is a convex surface at a paraxial position, and an object side surface of the second lens L2 and an image side surface of the third lens L3 are bonded, to form a bonding surface S4. The bonding surface S4 is a concave surface with respect to the second lens L2 (the image side surface of the second lens L2 is a concave surface at a paraxial position). The bonding surface S4 is a convex surface with respect to the third lens L3 (the object side surface of the third lens L3 is a convex surface at a paraxial position). An image side surface S5 of the third lens L3 is a convex surface at a paraxial position. A beam is further focused after passing through the second group G2, so that the total length of the lens group can be shortened, thereby facilitating miniaturization of the lens group. The doublet is disposed, so that a chromatic aberration can be eliminated, thereby improving imaging quality. The object side surface S3 of the second lens L2, the bonding surface S4, and the image side surface S5 of the third lens L3 are all spherical surfaces, so that manufacturing difficulty of the doublet can be reduced, and bonding precision of the second lens L2 and the third lens L3 can also be improved, thereby helping converge, on one image surface, a beam passing through the lens group 10.

The second lens L2 and the third lens L3 are both made of glass, and a refractive index temperature coefficient of glass is less than a refractive index temperature coefficient of plastic (the refractive index temperature coefficient of plastic is about 10 to 100 times the refractive index temperature coefficient of glass). Therefore, a lens made of glass can effectively compensate for a temperature effect. In addition, dispersion of the lens made of glass is relatively low, to help reduce dispersion. A relative refractive index temperature coefficient β of glass meets: −9×10⁻⁵≤β≤9×10⁻⁵. The refractive index temperature coefficient β is properly limited, and optical power is allocated, so that a temperature effect in the module 1 can be effectively eliminated. The second lens L2 and the third lens L3 may be made of glass with different refractive indexes, to better eliminate a chromatic aberration, thereby improving imaging quality. A combined focal length of the second lens L2 and the third lens L3 is f23, and f23 meets: 0≤f23/f≤3. Optical power, a refractive index temperature coefficient, and the combined focal length are properly set, so that a chromatic aberration can be effectively corrected, and a temperature effect can also be reduced.

Dispersion coefficients (Abbe numbers) of the second lens L2 and the third lens L3 are respectively V2 and V3, V2 meets: 15≤V2≤100, and V3 meets: 15≤V3≤100. A chromatic aberration of the lens group 10 can be corrected through proper optical power allocation and dispersion coefficient selection. For example, if the dispersion coefficient V2 of the second lens L2 meets: 15≤V2≤40, and the dispersion coefficient V3 of the third lens L3 meets: 40≤V3≤100, the dispersion coefficients of the second lens L2 and the third lens L3 can be effectively compensated for. Alternatively, if the dispersion coefficient V2 of the second lens L2 meets: 40≤V2≤100, and the dispersion coefficient V3 of the third lens L3 meets: 15≤V3≤40, the dispersion coefficients of the second lens L2 and the third lens L3 can also be effectively compensated for. The dispersion coefficients that are of the second lens L2 and the third lens L3 and that are compensated for each other are selected to correct a chromatic aberration of the lens group 10, so that an axial chromatic aberration CA1 of the lens group 10 can be made less than or equal to 10 μm.

The third group G3 has negative optical power. The third group G3 includes the fourth lens L4, the first lens L4 has the negative optical power, an object side surface S6 of the fourth lens L4 is a concave surface at a paraxial position, an image side surface S7 of the fourth lens L4 is a concave surface at a paraxial position, and the object side surface S6 and the image side surface S7 are both aspherical surfaces. A beam is diffused by using the fourth lens L4, and relative positions between the first group G1, the second group G2, the third group G3, and the fourth group G4 may be adjusted, to implement a long focal length of a high multiple (the high multiple is greater than or equal to 5×, and even can reach at least 10×). The object side surface S6 and the image side surface S7 are both aspherical surfaces, to help correct an aberration. The fourth lens L4 is made of resin, to help reduce costs.

The fourth group G4 has positive optical power. The fourth group G4 includes the fifth lens L5, the fifth lens L5 has the positive optical power, an object side surface S8 of the fifth lens L5 is a concave surface at a paraxial position, an image side surface S9 of the fifth lens L5 is a convex surface at a paraxial position, and the object side surface S8 and the image side surface S9 are both aspherical surfaces. The fifth lens L5 has the positive optical power, to help ensure a final focusing function, correct astigmatism, and control an incidence angle of a main light ray towards the image sensor. The object side surface S8 and the image side surface S9 are both aspherical surfaces, to help correct an aberration, and also help correct a peripheral aberration of an image, thereby improving imaging quality of the lens group. The fifth lens L5 is made of resin, to help reduce costs.

An aspherical curve equation of the lenses is represented as follows:

$$Z = \frac{c {r}^{2}}{1 + \sqrt{1 - ( 1 + k ) {c}^{2} {r}^{2}}} + {\sum }_{i = 2}^{n} {A}_{2 i} {r}^{2 i}$$

Z is a vector height parallel to a z-axis, r is a vertical distance between a point on an aspherical curve and the optical axis, c is a curvature at a vertex at which an aspherical surface intersects the optical axis, k is a conic coefficient, Ai is an i^{th}-order aspherical coefficient, and n is a total quantity of polynomial coefficients in a series.

The following further describes related lens parameters of the lens group according to some embodiments, as shown in the following Table 1. Meanings of symbols in Table 1 are in one-to-one correspondence with the meanings given above. Details are not described herein again. In the following table, each surface corresponds to one surface spacing, and a value of the surface spacing is a spacing, between the surface and a neighboring surface located on an image side of the surface, on the optical axis. For example, a surface spacing of the stop ST is −0.400 mm, indicating that a spacing between the stop ST and the object side surface S1 on the optical axis is −0.400 mm, where the minus sign “−” indicates that the stop ST is closer to the image side on the optical axis than the object side surface S1; and a surface spacing of the object side surface S1 is 0.834 mm, indicating that a spacing between the object side surface S1 and the object side surface S2 on the optical axis is 0.834 mm, where the object side surface S1 is closer to the object side on the optical axis than the object side surface S2. By analogy, details are not described again.

TABLE 1
Value instance 1 (length unit: mm)
TTL/f = 0.95; f23/f = 0.82;
SP4/LT = 0.23; |f/R51| + |f/R52| = 0.27;

| Surface | | Surface | Curvature | Surface | | Refractive | Dispersion |
|---|---|---|---|---|---|---|---|
| number | Description | type | radius | spacing | Material | index | coefficient |
| Object | / | Plane | / | / | / | / | / |
| surface | | | | | | | |
| ST | Aperture stop | Plane | / | −0.400 | / | / | / |
| S1 | First lens | Aspherical | 4.615 | 0.834 | Plastic | 1.5445 | 55.987 |
| | | surface | | | | | |
| S2 | | Aspherical | 17.288 | 0.100 | | | |
| | | surface | | | | | |
| S3 | Second lens | Spherical | 5.764 | 0.500 | Glass | 1.7174 | 29.51 |
| | | surface | | | | | |
| S4 | Third lens | Spherical | 3.109 | 1.341 | Glass | 1.5891 | 61.163 |
| | | surface | | | | | |
| S5 | | Spherical | 760.066 | 0.184 | | | |
| | | surface | | | | | |
| S6 | Fourth lens | Aspherical | −20.420 | 0.600 | Plastic | 1.5445 | 55.987 |
| | | surface | | | | | |
| S7 | | Aspherical | 4.073 | 3.180 | | | |
| | | surface | | | | | |
| S8 | Fifth lens | Aspherical | 62.794 | 1.645 | Plastic | 1.651 | 21.518 |
| | | surface | | | | | |
| S9 | | Aspherical | −370.200 | 0.300 | | | |
| | | surface | | | | | |
| S10 | Infrared cut- | Plane | / | 0.210 | / | / | / |
| S11 | off filter | Plane | | 4.875 | | | |
| S12 | Image sensor | Plane | / | / | / | / | / |
| | (image | | | | | | |
| | surface) | | | | | | |

The following Table 2 and Table 3 further give a conic constant K and an aspherical coefficient that correspond to each lens surface of the lens group in this specific embodiment (in an embodiment, there is an aspherical coefficient of a total of three orders). In Table 3, ImgH is a maximum image height of the lens group, TTL is a distance from a surface that is of the first lens and that faces the object side to the image surface on the optical axis, f1 is a focal length of the first lens, f2 is a focal length of the second lens, f3 is a focal length of the third lens, f4 is a focal length of the fourth lens, and f5 is a focal length of the fifth lens. Details are shown in the following Table 2 and Table 3:

TABLE 2

| Surface number | K | A4 | A6 |
|---|---|---|---|
| S1 | −3.614E−011 | 3.709E−004 | 9.497E−006 |
| S2 | −1.154E−010 | 1.039E−003 | −2.747E−005 |
| S3 | 0 | 0 | 0 |
| S4 | 0 | 0 | 0 |
| S5 | 0 | 0 | 0 |
| S6 | −1.264E−010 | 1.331E−003 | −6.578E−005 |
| S7 | 7.300E−011 | −3.134E−004 | 2.506E−004 |
| S8 | −1.313E−010 | −8.334E−003 | −5.622E−004 |
| S9 | −1.282E−010 | −6.799E−003 | −6.077E−005 |

TABLE 3

| Parameter | TTL | ImgH | f | f1 | f2 | f3 | f4 | f5 |
|---|---|---|---|---|---|---|---|---|
| Value (mm) | 13.77 | 2.8 | 14.50 | 11.26 | 18.79 | −23.31 | −6.16 | 81.92 |

Based on Table 1 to Table 3, the following describes an experimental test result of the lens group in these embodiments of this application.

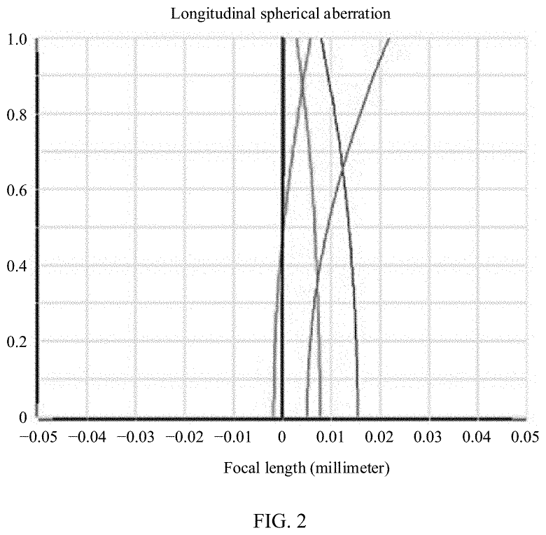

FIG. 2 to FIG. 5 respectively show simulation results of a spherical aberration (spherical aber), a field curve (field Curves), distortion (DiSTrtion), and an off-axis chromatic aberration according to embodiments of this application. It can be seen from the simulation results that, in this embodiment, on a premise that the lens group 10 meets a small size and a long focal length of a high multiple, an axial chromatic aberration (a longitudinal spherical aberration) of the lens group 10 is less than 25 μm, an off-axis chromatic aberration of the lens group 10 is less than 1 μm, and a distortion value of the lens group 10 is relatively good, so that a high-definition imaging requirement can also be ensured in a long-focus scenario.

Specifically, in FIG. 2, several curves respectively represent spherical aberrations caused after light of different wavelengths passes through the lens group, a vertical coordinate is a distance and is specifically a distance that is from an optical label of light of each wavelength to the optical axis and that is obtained when the light of each wavelength is incident along the optical axis, and a horizontal coordinate is a spherical aberration (a chromatic spherical aberration). It can be seen from the figure that the spherical aberrations caused after the light of the different wavelengths passes through the lens group are all less than 25 μm.

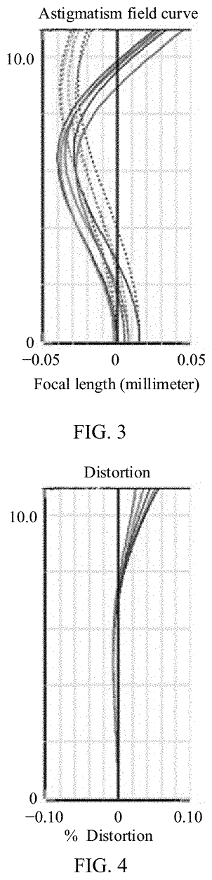

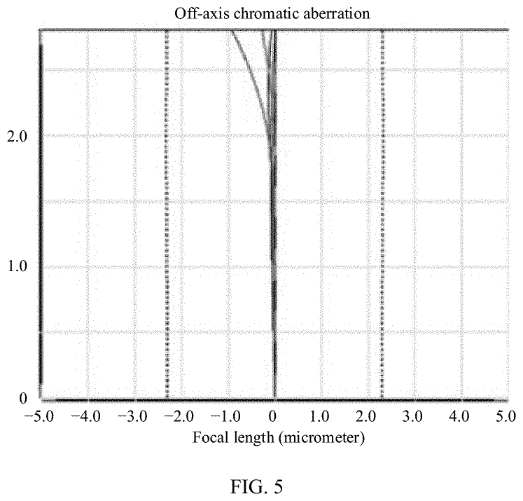

FIG. 3 shows astigmatism field curves, the several curves respectively represent field curves caused after light of different wavelengths passes through the lens group, a horizontal coordinate is a field of view, and a vertical coordinate is an image height, namely, different image heights caused after light of each wavelength is incident to the lens group along different field of view positions. FIG. 4 shows distortion curves, the several curves respectively represent distortion caused after light of different wavelengths passes through the lens group, a vertical coordinate is a field of view, and a horizontal coordinate is a distortion value. The distortion value is a value that is obtained by subtracting an ideal image height from an actual image height and then dividing an obtained difference by the ideal image height and that is obtained after light of each wavelength passes through the lens group. In FIG. 5, several curves respectively represent off-axis chromatic aberrations caused after light of different wavelengths passes through the lens group, a vertical coordinate is a distance and is a distance that is from an optical label of light of each wavelength to the optical axis and that is obtained when the light of each wavelength is incident along the optical axis, and a horizontal coordinate is an off-axis chromatic aberration. It can be seen from the figure that the off-axis chromatic aberrations caused after the light of the different wavelengths passes through the lens group are all less than 1 μm.

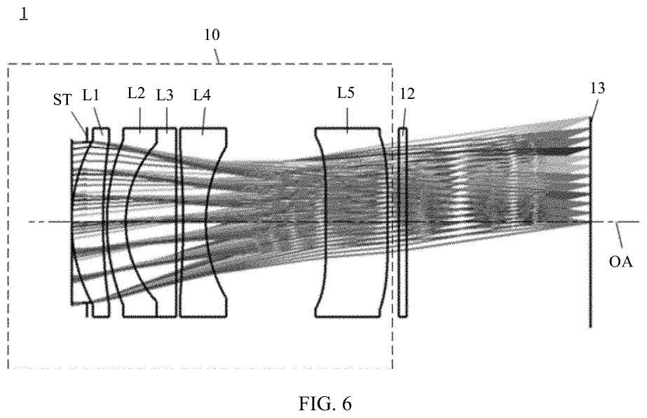

FIG. 6 shows that a beam converges on one image surface (image sensor) after passing through the lens group 10 and the light filter 12.

In the foregoing embodiments, a glass-plastic mixed lens group structure is used, and materials, shapes, thicknesses, chromatic aberration coefficients, optical power, and the like of the groups are properly allocated, so that dispersion of the lens group can be reduced, and a temperature effect of a long-focus photographing lens group can be effectively improved. In this way, light rays of different wavelengths can be focused on one image surface after passing through the lens group 10, thereby improving imaging performance and also making the long-focus lens group more compact. A long focal length can be implemented by using only a limited quantity of groups (or lenses), so that a thickness of the module 1 can be less than 68 mm. In other words, an off-axis chromatic aberration CA1 of the lens group 10 may be made less than or equal to 1 μm, an axial chromatic aberration CA2 of the lens group 10 may be made less than or equal to 10 μm, and a temperature drift coefficient Δf/Δ° C. may meet: −0.5 μm/° C.≤Δf/Δ° C.≤1.5 μm/° C.

### Embodiment 2

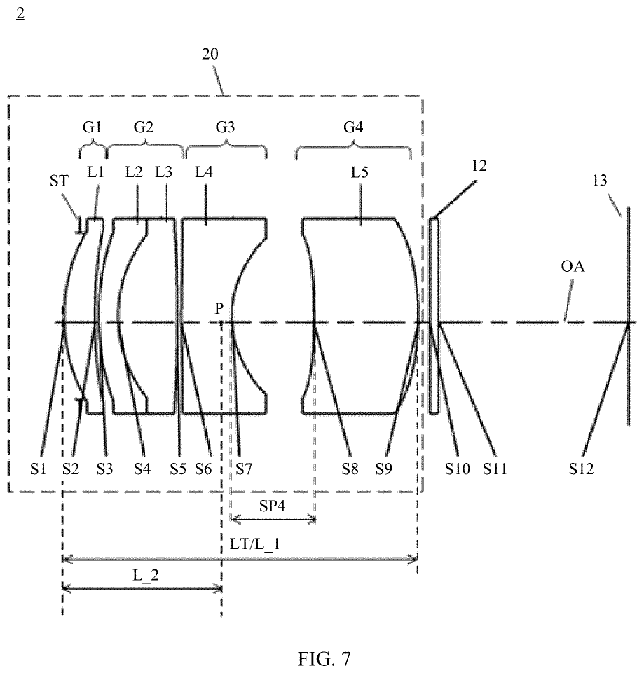

Refer to FIG. 7. In these embodiments, a lens group 20 may include an aperture stop ST, a first group G1, a second group G2, a third group G3, and a fourth group G4 that are sequentially disposed from an object side to an image side along an optical axis OA. The first group G1 includes a first lens L1. The second group G2 includes a doublet including a second lens L2 and a third lens L3. The third group G3 includes a fourth lens L4. The fourth group G4 includes a fifth lens L5. The aperture stop ST, the first lens L1, the second lens L2, the third lens L3, the fourth lens L4, and the fifth lens L5 may jointly constitute the lens group 20 in these embodiments of this application. The lens group 20, a light filter 12, and an image sensor 13 that are sequentially arranged from the object side to the image side along the optical axis constitute a camera module 2.

The first group G1 has positive optical power. The first group G1 includes the first lens L1, the first lens L1 has the positive optical power, an object side surface S1 of the first lens L1 is a convex surface at a paraxial position, an image side surface S2 of the first lens L1 is a concave surface at a paraxial position, and the object side surface S1 and the image side surface S2 are both aspherical surfaces. A beam entering from the aperture stop 10 is focused by using the first lens L1, so that a total length of the lens group can be shortened, thereby facilitating miniaturization of the lens group. The object side surface S1 and the image side surface S2 are both aspherical surfaces, to help correct an aberration. The first lens L1 is made of resin, to help reduce costs. A distance (also referred to as an optical length of the lens group 20) from the object side surface S1 of the first group G1 to an imaging surface of an object at infinity on the optical axis is TTL, and TTL/f≤1, to help implement relatively short TTL.

The second group G2 has positive optical power. The second group G2 includes the second lens L2 and the third lens L3, and the second lens L2 and the third lens L3 are bonded as the doublet to eliminate a chromatic aberration. An object side surface S3 of the second lens L2 is a convex surface at a paraxial position, and an object side surface of the second lens L2 and an image side surface of the third lens L3 are bonded, to form a bonding surface S4. The bonding surface S4 is a concave surface with respect to the second lens L2 (the image side surface of the second lens L2 is a concave surface at a paraxial position). The bonding surface S4 is a convex surface with respect to the third lens L3 (the object side surface of the third lens L3 is a convex surface at a paraxial position). An image side surface S5 of the third lens L3 is a convex surface at a paraxial position. A beam is further focused after passing through the second group G2, so that the total length of the lens group can be shortened, thereby facilitating miniaturization of the lens group. The doublet is disposed, so that a chromatic aberration can be eliminated, thereby improving imaging quality. The object side surface S3 of the second lens L2, the bonding surface S4, and the image side surface S5 of the third lens L3 are all spherical surfaces, so that manufacturing difficulty of the doublet can be reduced, and bonding precision of the second lens L2 and the third lens L3 can also be improved, thereby helping converge, on one image surface, a beam passing through the lens group 20.

The second lens L2 and the third lens L3 are both made of glass, and the second lens L2 and the third lens L3 may be made of glass with different refractive indexes, to better eliminate a chromatic aberration, thereby improving imaging quality. A combined focal length of the second lens L2 and the third lens L3 is f23, and f23 meets: 0≤f23/f≤3. Optical power, a refractive index temperature coefficient, and the combined focal length are properly set, so that a chromatic aberration can be effectively corrected, and a temperature effect can also be reduced.

Dispersion coefficients (Abbe numbers) of the second lens L2 and the third lens L3 are respectively V2 and V3, V2 meets: 15≤V2≤100, and V3 meets: 15≤V3≤100. A chromatic aberration of the lens group 20 can be corrected through proper optical power allocation and dispersion coefficient selection. For example, if the dispersion coefficient V2 of the second lens L2 meets: 15≤V2≤40, and the dispersion coefficient V3 of the third lens L3 meets: 40≤V3≤100, the dispersion coefficients of the second lens L2 and the third lens L3 can be effectively compensated for. Alternatively, if the dispersion coefficient V2 of the second lens L2 meets: 40≤V2≤100, and the dispersion coefficient V3 of the third lens L3 meets: 15≤V3≤40, the dispersion coefficients of the second lens L2 and the third lens L3 can also be effectively compensated for. The dispersion coefficients that are of the second lens L2 and the third lens L3 and that are compensated for each other are selected to correct a chromatic aberration of the lens group 20, so that an axial chromatic aberration CA1 of the lens group 20 can be made less than or equal to 3 μm.

The third group G3 has negative optical power. The third group G3 includes the fourth lens L4, the first lens L4 has the negative optical power, an object side surface S6 of the fourth lens L4 is a concave surface at a paraxial position, an image side surface S7 of the fourth lens L4 is a concave surface at a paraxial position, and the object side surface S6 and the image side surface S7 are both aspherical surfaces. A beam is diffused by using the fourth lens L4, and relative positions between the first group G1, the second group G2, the third group G3, and the fourth group G4 may be adjusted, to implement a long focal length of a high multiple (the high multiple is greater than or equal to 5×, and even can reach at least 10×). The object side surface S6 and the image side surface S7 are both aspherical surfaces, to help correct an aberration. The fourth lens L4 is made of resin, to help reduce costs.

The fourth group G4 has positive optical power. The fourth group G4 includes the fifth lens L5, the fifth lens L5 has the positive optical power, an object side surface S8 of the fifth lens L5 is a concave surface at a paraxial position, an image side surface S9 of the fifth lens L5 is a convex surface at a paraxial position, and the object side surface S8 and the image side surface S9 are both aspherical surfaces. The fifth lens L5 has the positive optical power, to help ensure a final focusing function, correct astigmatism, and control an incidence angle of a main light ray towards the image sensor. The object side surface S8 and the image side surface S9 are both aspherical surfaces, to help correct an aberration, and also help correct a peripheral aberration of an image, thereby improving imaging quality of the lens group. The fifth lens L5 is made of resin, to help reduce costs.

An aspherical curve equation of the lenses is represented as follows:

$$Z = \frac{c {r}^{2}}{1 + \sqrt{1 - ( 1 + k ) {c}^{2} {r}^{2}}} + {\sum }_{i = 2}^{n} {A}_{2 i} {r}^{2 i}$$

Z is a vector height parallel to a z-axis, r is a vertical distance between a point on an aspherical curve and the optical axis, c is a curvature at a vertex at which an aspherical surface intersects the optical axis, k is a conic coefficient, Ai is an i^{th}-order aspherical coefficient, and n is a total quantity of polynomial coefficients in a series.

The following further describes related lens parameters of the lens according to some scenarios, as shown in the following Table 4. Meanings of symbols in Table 4 are in one-to-one correspondence with the meanings given above. Details are not described herein again. In the following table, each surface corresponds to one surface spacing, and a value of the surface spacing is a spacing, between the surface and a neighboring surface located on an image side of the surface, on the optical axis. For example, a surface spacing of the stop ST is −0.400 mm, indicating that a spacing between the stop ST and the object side surface S1 on the optical axis is −0.400 mm, where the minus sign “−” indicates that the stop ST is closer to the image side on the optical axis than the object side surface S1; and a surface spacing of the object side surface S1 is 0.787 mm, indicating that a spacing between the object side surface S1 and the object side surface S2 on the optical axis is 0.787 mm, where the object side surface S1 is closer to the object side on the optical axis than the object side surface S2. By analogy, details are not described again.

TABLE 4
Value instance 2 (length unit: mm)
TTL/f = 1; f23/f = 0.79;
SP4/LT = 0.146; |f/R51| + |f/R52| = 2.81;

| Surface | | Surface | Curvature | Surface | | Refractive | Dispersion |
|---|---|---|---|---|---|---|---|
| number | Description | type | radius | spacing | Material | index | coefficient |
| Object | / | Plane | / | / | / | / | / |
| surface | | | | | | | |
| ST | Aperture stop | Plane | / | −0.400 | / | / | / |
| S1 | First lens | Aspherical | 4.444 | 0.787 | Plastic | 1.5445 | 55.987 |
| | | surface | | | | | |
| S2 | | Aspherical | 13.070 | 0.100 | | | |
| | | surface | | | | | |
| S3 | Second lens | Spherical | 6.516 | 0.500 | Glass | 1.7174 | 29.51 |
| | | surface | | | | | |
| S4 | Third lens | Spherical | 3.330 | 1.522 | Glass | 1.5891 | 61.163 |
| | | surface | | | | | |
| S5 | | Spherical | −36.770 | 0.100 | | | |
| | | surface | | | | | |
| S6 | Fourth lens | Aspherical | 18.551 | 1.290 | Plastic | 1.5445 | 55.987 |
| | | surface | | | | | |
| S7 | | Aspherical | 2.360 | 2.123 | | | |
| | | surface | | | | | |
| S8 | Fifth lens | Aspherical | −17.187 | 2.669 | Plastic | 1.5445 | 55.987 |
| | | surface | | | | | |
| S9 | | Aspherical | −7.384 | 0.300 | | | |
| | | surface | | | | | |
| S10 | Infrared cut- | Plane | / | 0.210 | / | / | / |
| S11 | off filter | Plane | | 4.900 | | | |
| S12 | Image sensor | Plane | / | / | / | / | / |
| | (image | | | | | | |
| | surface) | | | | | | |

The following Table 5 and Table 6 further give a conic constant K and an aspherical coefficient that correspond to each lens surface of the lens group in this specific embodiment (in an embodiment, there is an aspherical coefficient of a total of three orders). In Table 6, ImgH is a maximum image height of the lens group, TTL is a distance from a surface that is of the first lens and that faces the object side to the image surface on the optical axis, f1 is a focal length of the first lens, f2 is a focal length of the second lens, f3 is a focal length of the third lens, f4 is a focal length of the fourth lens, and f5 is a focal length of the fifth lens. Details are shown in the following Table 5 and Table 6:

TABLE 5

| Surface | | | |
|---|---|---|---|
| number | K | A4 | A6 |
| S1 | −4.711E−011 | 4.963E−004 | 1.750E−005 |
| S2 | −1.262E−010 | 1.132E−003 | −3.173E−005 |
| S3 | 0 | 0 | 0 |
| S4 | 0 | 0 | 0 |
| S5 | 0 | 0 | 0 |
| S6 | −9.822E−011 | −6.114E−003 | 2.926E−004 |
| S7 | −1.825E−010 | −1.287E−002 | −1.852E−004 |
| S8 | 3.763E−010 | −5.541E−003 | −6.871E−004 |
| S9 | −6.408E−011 | −3.338E−003 | −1.640E−004 |

TABLE 6

| Parameter | TTL | ImgH | f | f1 | f2 | f3 | f4 | f5 |
|---|---|---|---|---|---|---|---|---|
| Value (mm) | 14.50 | 2.8 | 14.50 | 11.94 | 21.87 | −44.21 | -5.09 | 21.62 |

Based on Table 4 to Table 6, the following describes an experimental test result of the lens group in this embodiment of this application.

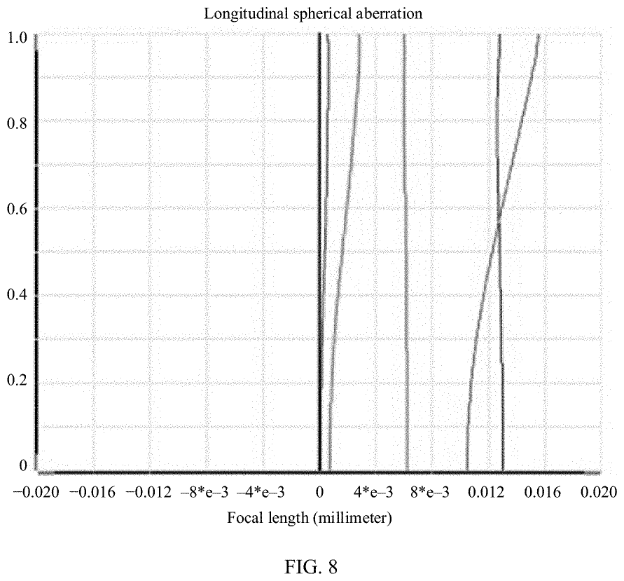

FIG. 8 to FIG. 11 respectively show simulation results of a spherical aberration (spherical aber), a field curve (field Curves), distortion (DiSTrtion), and an off-axis chromatic aberration according to embodiments of this application. It can be seen from the simulation results that, in these embodiments, on a premise that the lens group 20 meets a small size and a long focal length of a high multiple, an axial chromatic aberration (a longitudinal spherical aberration) of the lens group 20 is less than 16 μm, an off-axis chromatic aberration of the lens group 20 is less than 1 μm, and a distortion value of the lens group 20 is relatively good, so that a high-definition imaging requirement can also be ensured in a long-focus scenario.

In FIG. 8, several curves respectively represent spherical aberrations caused after light of different wavelengths passes through the lens group, a vertical coordinate is a distance and is specifically a distance that is from an optical label of light of each wavelength to the optical axis and that is obtained when the light of each wavelength is incident along the optical axis, and a horizontal coordinate is a spherical aberration (a chromatic spherical aberration). It can be seen from the figure that the spherical aberrations caused after the light of the different wavelengths passes through the lens group are all less than 16 μm.

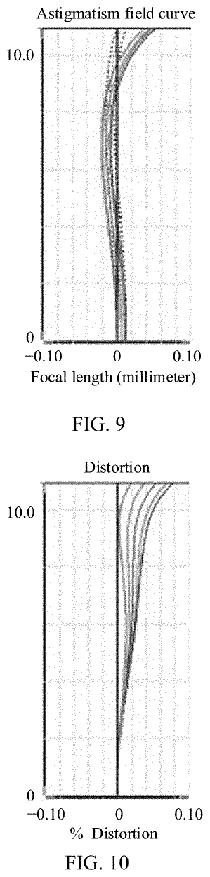

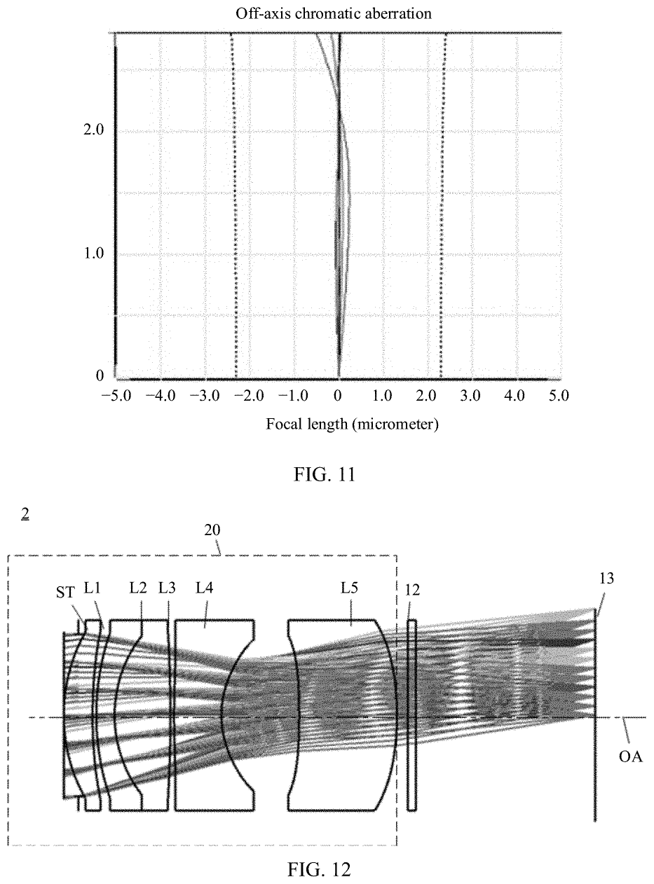

FIG. 9 shows astigmatism field curves, the curves respectively represent field curves caused after light of different wavelengths passes through the lens group, a horizontal coordinate is a field of view, and a vertical coordinate is an image height, namely, different image heights caused after light of each wavelength is incident to the lens group along different field of view positions. FIG. 10 shows distortion curves, the several curves respectively represent distortion caused after light of different wavelengths passes through the lens group, a vertical coordinate is a field of view, and a horizontal coordinate is a distortion value. The distortion value is a value that is obtained by subtracting an ideal image height from an actual image height and then dividing an obtained difference by the ideal image height and that is obtained after light of each wavelength passes through the lens group. In FIG. 11, several curves respectively represent off-axis chromatic aberrations caused after light of different wavelengths passes through the lens group, a vertical coordinate is a distance and is specifically a distance that is from an optical label of light of each wavelength to the optical axis and that is obtained when the light of each wavelength is incident along the optical axis, and a horizontal coordinate is an off-axis chromatic aberration. It can be seen from the figure that the off-axis chromatic aberrations caused after the light of the different wavelengths passes through the lens group are all less than 1 μm.

FIG. 12 shows that a beam converges on one image surface (image sensor) after passing through the lens group 20 and the light filter 12.

In the foregoing embodiments, a glass-plastic mixed lens group structure is used, and materials, shapes, thicknesses, chromatic aberration coefficients, optical power, and the like of the groups are properly allocated, so that dispersion of the lens group can be reduced, and a temperature effect of a long-focus photographing lens group can be effectively improved. In this way, light rays of different wavelengths can be focused on one image surface after passing through the lens group 20, thereby improving imaging performance and also making the long-focus lens group more compact. A long focal length can be implemented by using only a limited quantity of groups (or lenses), so that a thickness of the module 2 can be less than 68 mm. Specifically, an off-axis chromatic aberration CA1 of the lens group 20 may be made less than or equal to 1 μm, an axial chromatic aberration CA2 of the lens group 20 may be made less than or equal to 3 μm, and a temperature drift coefficient Δf/Δ° C. may meet: −0.5 μm/° C.≤Δf/Δ° C.≤1.5 μm/° C.

### Embodiment 3

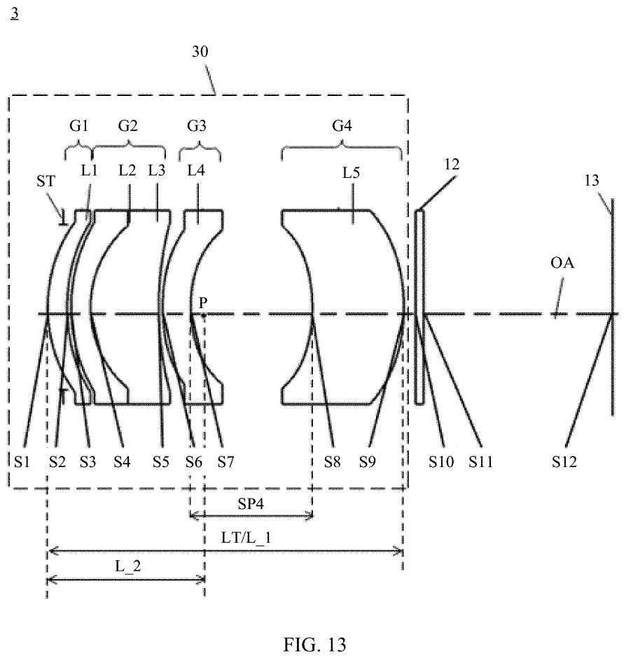

Refer to FIG. 13. In these embodiments, a lens group 30 may include an aperture stop ST, a first group G1, a second group G2, a third group G3, and a fourth group G4 that are sequentially disposed from an object side to an image side along an optical axis OA. The first group G1 includes a first lens L1. The second group G2 includes a doublet including a second lens L2 and a third lens L3. The third group G3 includes a fourth lens L4. The fourth group G4 includes a fifth lens L5. The aperture stop ST, the first lens L1, the second lens L2, the third lens L3, the fourth lens L4, and the fifth lens L5 may jointly constitute the lens group 30 in these embodiments of this application. The lens group 30, a light filter 12, and an image sensor 13 that are sequentially arranged from the object side to the image side along the optical axis constitute a camera module 3.

The first group G1 has positive optical power. The first group G1 includes the first lens L1, the first lens L1 has the positive optical power, an object side surface S1 of the first lens L1 is a convex surface at a paraxial position, an image side surface S2 of the first lens L1 is a concave surface at a paraxial position, and the object side surface S1 and the image side surface S2 are both aspherical surfaces. A beam entering from the aperture stop 10 is focused by using the first lens L1, so that a total length of the lens group can be shortened, thereby facilitating miniaturization of the lens group. The object side surface S1 and the image side surface S2 are both aspherical surfaces, to help correct an aberration. The first lens L1 is made of resin, to help reduce costs. A distance (also referred to as an optical length of the lens group 30) from the object side surface S1 of the first group G1 to an imaging surface of an object at infinity on the optical axis is TTL, and TTL/f≤0.95, to help implement relatively short TTL.

The second group G2 has positive optical power. The second group G2 includes the second lens L2 and the third lens L3, and the second lens L2 and the third lens L3 are bonded as the doublet to eliminate a chromatic aberration. An object side surface S3 of the second lens L2 is a convex surface at a paraxial position, and an object side surface of the second lens L2 and an image side surface of the third lens L3 are bonded, to form a bonding surface S4. The bonding surface S4 is a concave surface with respect to the second lens L2 (the image side surface of the second lens L2 is a concave surface at a paraxial position). The bonding surface S4 is a convex surface with respect to the third lens L3 (the object side surface of the third lens L3 is a convex surface at a paraxial position). An image side surface S5 of the third lens L3 is a convex surface at a paraxial position. A beam is further focused after passing through the second group G2, so that the total length of the lens group can be shortened, thereby facilitating miniaturization of the lens group. The doublet is disposed, so that a chromatic aberration can be eliminated, thereby improving imaging quality. The object side surface S3 of the second lens L2, the bonding surface S4, and the image side surface S5 of the third lens L3 are all spherical surfaces, so that manufacturing difficulty of the doublet can be reduced, and bonding precision of the second lens L2 and the third lens L3 can also be improved, thereby helping converge, on one image surface, a beam passing through the lens group 30.

The second lens L2 and the third lens L3 are both made of glass, and a refractive index temperature coefficient of glass is less than a refractive index temperature coefficient of plastic (the refractive index temperature coefficient of plastic is about 10 to 100 times the refractive index temperature coefficient of glass). Therefore, a lens made of glass can effectively compensate for a temperature effect. In addition, dispersion of the lens made of glass is relatively low, to help reduce dispersion. A relative refractive index temperature coefficient β of glass meets: −9×10⁻⁵≤β≤9×10⁻⁵. The refractive index temperature coefficient β is properly limited, and optical power is allocated, so that a temperature effect in the module 3 can be effectively eliminated. The second lens L2 and the third lens L3 may be made of glass with different refractive indexes, to better eliminate a chromatic aberration, thereby improving imaging quality. A combined focal length of the second lens L2 and the third lens L3 is f23, and f23 meets: 0≤f23/f≤3. Optical power, a refractive index temperature coefficient, and the combined focal length are properly set, so that a chromatic aberration can be effectively corrected, and a temperature effect can also be reduced.

Dispersion coefficients (Abbe numbers) of the second lens L2 and the third lens L3 are respectively V2 and V3, V2 meets: 15≤V2≤100, and V3 meets: 15≤V3≤100. A chromatic aberration of the lens group 30 can be corrected through proper optical power allocation and dispersion coefficient selection. For example, if the dispersion coefficient V2 of the second lens L2 meets: 15≤V2≤40, and the dispersion coefficient V3 of the third lens L3 meets: 40≤V3≤100, the dispersion coefficients of the second lens L2 and the third lens L3 can be effectively compensated for. Alternatively, if the dispersion coefficient V2 of the second lens L2 meets: 40≤V2≤100, and the dispersion coefficient V3 of the third lens L3 meets: 15≤V3≤40, the dispersion coefficients of the second lens L2 and the third lens L3 can also be effectively compensated for. The dispersion coefficients that are of the second lens L2 and the third lens L3 and that are compensated for each other are selected to correct a chromatic aberration of the lens group 30, so that an axial chromatic aberration CA1 of the lens group 30 can be made less than or equal to 7 μm.

The third group G3 has negative optical power. The third group G3 includes the fourth lens L4, the first lens L4 has the negative optical power, an object side surface S6 of the fourth lens L4 is a convex surface at a paraxial position, an image side surface S7 of the fourth lens L4 is a concave surface at a paraxial position, and the object side surface S6 and the image side surface S7 are both aspherical surfaces. A beam is diffused by using the fourth lens L4, and relative positions between the first group G1, the second group G2, the third group G3, and the fourth group G4 may be adjusted, to implement a long focal length of a high multiple (the high multiple is greater than or equal to 5×, and even can reach at least 10×). The object side surface S6 and the image side surface S7 are both aspherical surfaces, to help correct an aberration. The fourth lens L4 is made of resin, to help reduce costs.

The fourth group G4 has positive optical power. The fourth group G4 includes the fifth lens L5, the fifth lens L5 has the positive optical power, an object side surface S8 of the fifth lens L5 is a concave surface at a paraxial position, an image side surface S9 of the fifth lens L5 is a convex surface at a paraxial position, and the object side surface S8 and the image side surface S9 are both aspherical surfaces. The fifth lens L5 has the positive optical power, to help ensure a final focusing function, correct astigmatism, and control an incidence angle of a main light ray towards the image sensor. The object side surface S8 and the image side surface S9 are both aspherical surfaces, to help correct an aberration, and also help correct a peripheral aberration of an image, thereby improving imaging quality of the lens group. The fifth lens L5 is made of resin, to help reduce costs.

An aspherical curve equation of the lenses is represented as follows:

$$Z = \frac{c {r}^{2}}{1 + \sqrt{1 - ( 1 + k ) {c}^{2} {r}^{2}}} + {\sum }_{i = 2}^{n} {A}_{2 i} {r}^{2 i}$$

Z is a vector height parallel to a z-axis, r is a vertical distance between a point on an aspherical curve and the optical axis, c is a curvature at a vertex at which an aspherical surface intersects the optical axis, k is a conic coefficient, Ai is an i^{th}-order aspherical coefficient, and n is a total quantity of polynomial coefficients in a series.

The following further describes related lens parameters of the lens group in some scenarios, as shown in the following Table 7. Meanings of symbols in Table 7 are in one-to-one correspondence with the meanings given above. Details are not described herein again. In the following table, each surface corresponds to one surface spacing, and a value of the surface spacing is a spacing, between the surface and a neighboring surface located on an image side of the surface, on the optical axis. For example, a surface spacing of the stop ST is −0.400 mm, indicating that a spacing between the stop ST and the object side surface S1 on the optical axis is −0.400 mm, where the minus sign “−” indicates that the stop ST is closer to the image side on the optical axis than the object side surface S1; and a surface spacing of the object side surface S1 is 0.500 mm, indicating that a spacing between the object side surface S1 and the object side surface S2 on the optical axis is 0.500 mm, where the object side surface S1 is closer to the object side on the optical axis than the object side surface S2. By analogy, details are not described again.

TABLE 7
Value instance 3 (length unit: mm)
TTL/f = 1; f23/f = 1.07;
SP4/LT = 0.216; |f/R51| + |f/R52| = 6.49;

| Surface | | Surface | Curvature | Surface | | Refractive | Dispersion |
|---|---|---|---|---|---|---|---|
| number | Description | type | radius | spacing | Material | index | coefficient |
| Object | / | Plane | / | / | / | / | / |
| surface | | | | | | | |
| ST | Aperture | Plane | / | −0.400 | / | / | / |
| | stop | | | | | | |
| S1 | First lens | Aspherical | 3.954 | 0.500 | Plastic | 1.5445 | 55.987 |
| | | surface | | | | | |
| S2 | | Aspherical | 4.822 | 0.100 | | | |
| | | surface | | | | | |
| S3 | Second lens | Spherical | 4.351 | 0.499 | Glass | 1.7174 | 29.51 |
| | | surface | | | | | |
| S4 | Third lens | Spherical | 2.787 | 1.751 | Glass | 1.5891 | 61.163 |
| | | surface | | | | | |
| S5 | | Spherical | 8.503 | 0.100 | | | |
| | | surface | | | | | |
| S6 | Fourth lens | Aspherical | 5.036 | 0.721 | Plastic | 1.6137 | 25.98 |
| | | surface | | | | | |
| S7 | | Aspherical | 3.749 | 3.124 | | | |
| | | surface | | | | | |
| S8 | Fifth lens | Aspherical | −4.301 | 2.349 | Plastic | 1.5445 | 55.987 |
| | | surface | | | | | |
| S9 | | Aspherical | −4.638 | 0.300 | | | |
| | | surface | | | | | |
| S10 | Infrared cut- | Plane | / | 0.210 | / | / | / |
| S11 | off filter | Plane | | 4.851 | | | |
| S12 | Image sensor | Plane | / | / | / | / | / |
| | (image | | | | | | |
| | surface) | | | | | | |

The following Table 8 and Table 9 further give a conic constant K and an aspherical coefficient that correspond to each lens surface of the lens group in this specific embodiment (in an embodiment, there is an Aspherical coefficient of a total of three orders). In Table 9, ImgH is a maximum image height of the lens group, TTL is a distance from a surface that is of the first lens and that faces the object side to the image surface on the optical axis, f1 is a focal length of the first lens, f2 is a focal length of the second lens, f3 is a focal length of the third lens, f4 is a focal length of the fourth lens, and f5 is a focal length of the fifth lens. Details are shown in the following Table 8 and Table 9:

TABLE 8

| Surface number | K | A4 | A6 |
|---|---|---|---|
| S1 | −9.962E−011 | E046E−003 | 3.573E−005 |
| S2 | −2.770E−010 | 2.713E−003 | 2.118E−005 |
| S3 | 0 | 0 | 0 |
| S4 | 0 | 0 | 0 |
| S5 | 0 | 0 | 0 |
| S6 | 1.566E−010 | 1.011E−002 | −2.905E−004 |
| S7 | 1.806E−010 | 1.325E−002 | 4.327E−004 |
| S8 | 1.587E−010 | −5.008E−003 | −1.455E−003 |
| S9 | 1.820E−010 | −2.067E−003 | −2.199E−004 |

TABLE 9

| Parameter | TTL | ImgH | f | f1 | f2 | f3 | f4 | f5 |
|---|---|---|---|---|---|---|---|---|
| Value (mm) | 14.49 | 2.8 | 14.50 | 33.41 | 13.13 | −8.33 | −30.22 | 73.96 |

Based on Table 7, Table 8, and Table 9, the following describes an experimental test result of the lens group in these embodiments of this application.

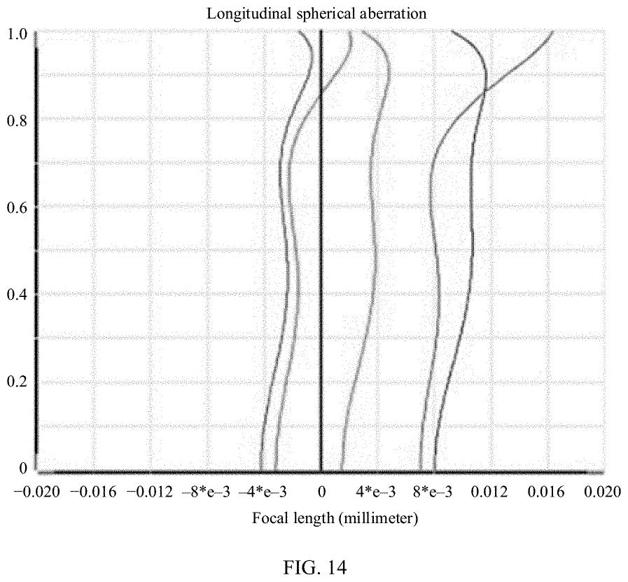

FIGS. 14 to 17 respectively show simulation results of a spherical aberration (spherical aber), a field curve (field Curves), distortion (DiSTrtion), and an off-axis chromatic aberration according to embodiments of this application. It can be seen from the simulation results that, in these embodiments, on a premise that the lens group 30 meets a small size and a long focal length of a high multiple, an axial chromatic aberration (a longitudinal spherical aberration) of the lens group 30 is less than 20 μm, an off-axis chromatic aberration of the lens group 30 is less than 1 μm, and a distortion value of the lens group 30 is relatively good, so that a high-definition imaging requirement can also be ensured in a long-focus scenario.

Specifically, in FIG. 14, several curves respectively represent spherical aberrations caused after light of different wavelengths passes through the lens group, a vertical coordinate is a distance and is specifically a distance that is from an optical label of light of each wavelength to the optical axis and that is obtained when the light of each wavelength is incident along the optical axis, and a horizontal coordinate is a spherical aberration (a chromatic spherical aberration). It can be seen from the figure that the spherical aberrations caused after the light of the different wavelengths passes through the lens group are all less than 20 μm.

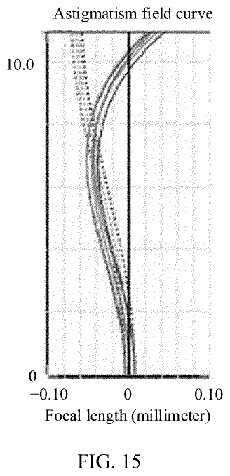

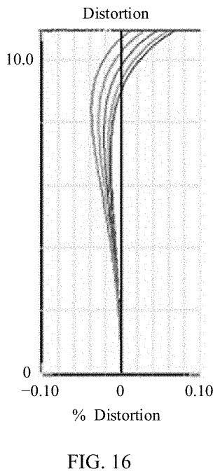

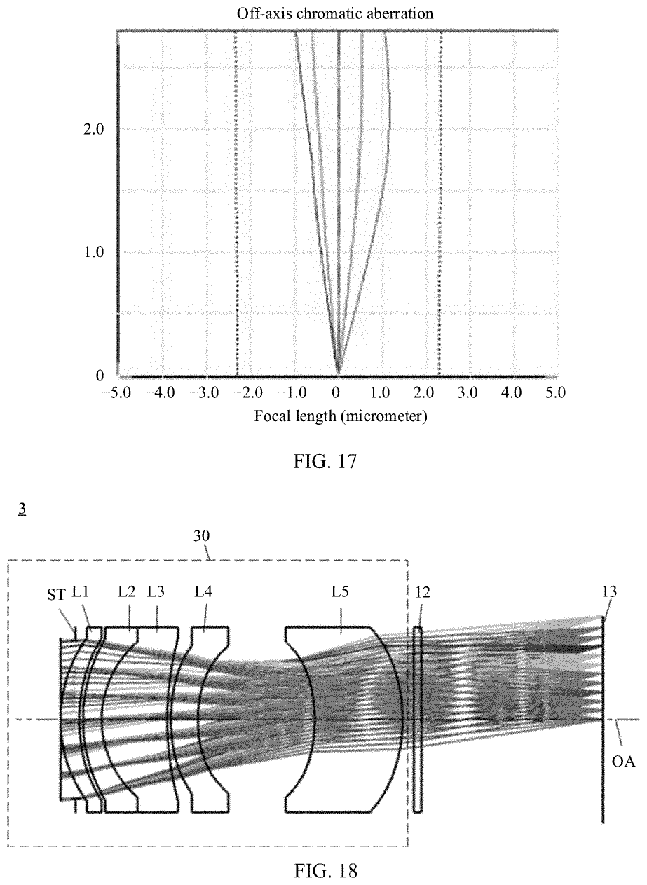

FIG. 15 shows astigmatism field curves, the curves respectively represent field curves caused after light of different wavelengths passes through the lens group, a horizontal coordinate is a field of view, and a vertical coordinate is an image height, namely, different image heights caused after light of each wavelength is incident to the lens group along different field of view positions. FIG. 16 shows distortion curves, the several curves respectively represent distortion caused after light of different wavelengths passes through the lens group, a vertical coordinate is a field of view, and a horizontal coordinate is a distortion value. The distortion value is a value that is obtained by subtracting an ideal image height from an actual image height and then dividing an obtained difference by the ideal image height and that is obtained after light of each wavelength passes through the lens group. In FIG. 17, several curves respectively represent off-axis chromatic aberrations caused after light of different wavelengths passes through the lens group, a vertical coordinate is a distance and is specifically a distance that is from an optical label of light of each wavelength to the optical axis and that is obtained when the light of each wavelength is incident along the optical axis, and a horizontal coordinate is an off-axis chromatic aberration. It can be seen from the figure that the off-axis chromatic aberrations caused after the light of the different wavelengths passes through the lens group are all less than 1.5 μm.

FIG. 18 shows that a beam converges on one image surface S11 after passing through the lens group 30 and the light filter 12.

In the foregoing embodiments, a glass-plastic mixed lens group structure is used, and materials, shapes, thicknesses, chromatic aberration coefficients, optical power, and the like of the groups are properly allocated, so that dispersion of the lens group can be reduced, and a temperature effect of a long-focus photographing lens group can be effectively improved. In this way, light rays of different wavelengths can be focused on one image surface after passing through the lens group 30, thereby improving imaging performance and also making the long-focus lens group more compact. A long focal length can be implemented by using only a limited quantity of groups (or lenses), so that a thickness of the module 3 can be less than 68 mm. Specifically, an off-axis chromatic aberration CA1 of the lens group 30 may be made less than or equal to 1 μm, an axial chromatic aberration CA2 of the lens group 30 may be made less than or equal to 7 μm, and a temperature drift coefficient Δf/Δ° C. may meet: −0.5 μm/° C.≤Δf/Δ° C.≤1.5 μm/° C.

### Embodiment 4

Embodiment 4 of this application provides a camera module. The camera module includes the lens group provided in any one of Embodiments 1 to 3. The camera module may be an apparatus such as a camera module or an infrared camera module. The lens group is disposed in the camera module, so that a lens group length of the camera module can be shortened, and a camera module with a long focal length, a small size, temperature insensitivity, and high imaging quality can be implemented on a premise of ensuring that the camera module is relatively thin. In addition, the camera module may further include a light filter and an image sensor, disposed on a side that is of the lens group and that faces an image side, and the image sensor is located on the image side of the lens group. The light filter may be an infrared cut-off filter, and infrared light is cut off and filtered by using the infrared cut-off filter.

### Embodiment 5

Embodiment 5 of this application provides a terminal device. The terminal device includes the camera module provided in Embodiment 4. The camera module with the lens group is disposed in the terminal device, so that various photographing application scenarios of a higher focal length multiple (especially, a long focal length of at least 5×) can be implemented, thereby improving photographing quality, and enhancing a function of the terminal device; and a thickness of the terminal device can be effectively reduced, thereby improving user experience. The terminal device may be a device such as a mobile phone or a tablet computer.

### Embodiment 6

Embodiment 6 of this application provides a mobile phone. The mobile phone includes the camera module provided in Embodiment 4.

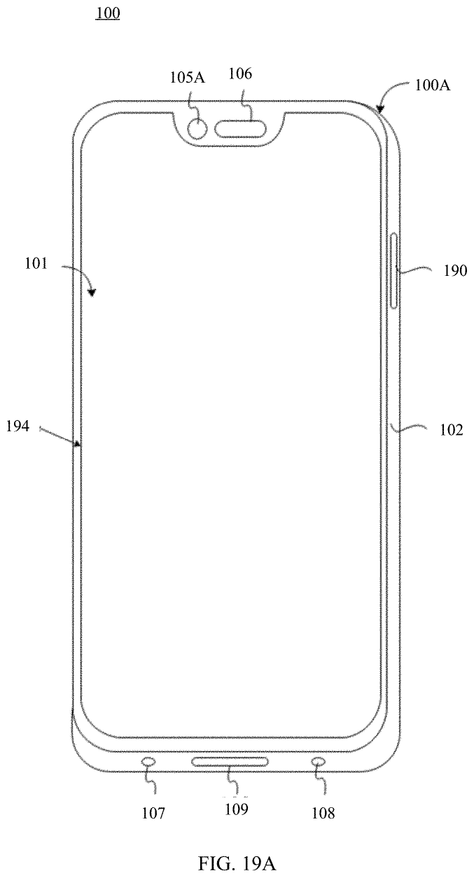

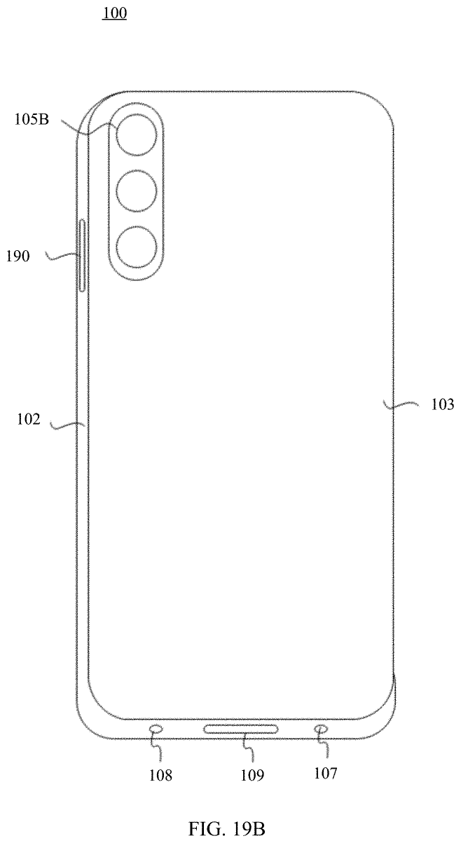

As shown in FIG. 19A and FIG. 19B, a mobile phone 100 may include a housing 100A. The housing 100A may include a front cover 101, a rear cover 103, and a bezel 102. The front cover 101 and the rear cover 103 are oppositely disposed. The bezel 102 surrounds the front cover 101 and the rear cover 103 and connects the front cover 101 and the rear cover 102 together. The front cover 101 may be a glass cover, and a display 194 is disposed under the front cover 101. In the mobile phone 100, input/output components may be disposed around the outer circumference of the housing 100A. For example, a front-facing camera (a lens group located on a surface on which the display is located) 105A and a telephone receiver 106 may be disposed at the top of the front cover 101. A push-button 190 may be disposed on an edge of the bezel 102, and a microphone, a speaker 108, and a USB interface 109 may be disposed on a bottom edge of the bezel 101. For example, at least one rear-facing camera (a lens group located on a surface that faces away from the display) 105B may be disposed at the top of the rear cover 102.

The camera module with the lens group is disposed in the mobile phone, so that a lens group length of the camera module can be shortened, and a camera module with a long focal length, a small size, temperature insensitivity, and high imaging quality can be implemented on a premise of ensuring that the camera module is relatively thin. In other embodiments, the front-facing camera 105A of the mobile phone 100 may be disposed under the display 194, that is, the front-facing camera 105A is an under display camera. Alternatively, in other embodiments, displays 194 are disposed on both the front cover 101 and the rear cover 103 of the mobile phone 100.

The camera module with the lens group is disposed in the mobile phone, so that various photographing application scenarios of a higher focal length multiple (especially, a long focal length of at least 5×) can be implemented, thereby improving photographing quality; and a thickness of the mobile phone can be effectively reduced, thereby enhancing a function of the terminal device, and improving user experience.

Several embodiments are shown above, but a lens structure is not limited to the content disclosed in the foregoing embodiments. For example, in some embodiments, any one or more of the first lens, the fourth lens, and the fifth lens are made of glass, and one or both of the second lens and the third lens are made of plastic. In some embodiments, any one or more of the object side surface S3 of the second lens L2, the bonding surface S4 of the second lens L2 and the third lens L3, and the image side surface S5 of the third lens L3 are aspherical surfaces, and/or any one or more of the object side surface S1 of the first lens L1, the image side surface S2 of the first lens L1, the object side surface S6 of the fourth lens L4, the image side surface S7 of the fourth lens L4, the object side surface S8 of the fifth lens L5, and the image side surface S9 of the fifth lens L5 are spherical surfaces. In some embodiments, a shape of any side surface of the first lens to the fifth lens is not limited to the concave surface or the convex surface disclosed in the foregoing embodiments.

It can be learned that, in the foregoing aspects, optical power of a lens in each group is designed in matching with the doublet, so that a long-focus lens group can be obtained, to help improve lens group imaging quality in a compact system, and implement an imaging effect of a long focal length, a small chromatic aberration, a small temperature drift, and a small size. Therefore, in a scenario such as video recording or photographing preview, a temperature drift does not need to be corrected by using an algorithm, and the long-focus lens group can be used in a scenario in which a terminal device takes and records an image, for example, a lens group of a portable electronic product such as a mobile phone, a tablet computer, or a monitor is used to take an external video or photo, including various photographing application scenarios in different large fields of view.

Embodiment 1. A lens group, including a first group, a second group, a third group, and a fourth group that are sequentially disposed from an object side to an image side along an optical axis, where

the first group has positive optical power;

the second group has positive optical power, the second group includes a second lens and a third lens that are sequentially disposed from the object side to the image side along the optical axis, and the second lens and the third lens are bonded as a doublet;

the third group has negative optical power; and

an optical length of the lens group is TTL, an effective focal length of the lens group is f, and TTL and f meet:

TTL/f≤1.

Embodiment 2. The lens group according to Embodiment 1, where dispersion coefficients of the second lens and the third lens are respectively V2 and V3, wherein V2 meets: 15≤V2≤100, and V3 meets: 15≤V3≤100.

Embodiment 3. The lens group according to Embodiment 2, where V2 and V3 meet: 15≤V2≤40, and 40≤V3≤100; or

V2 and V3 meet: 40≤V2≤100, and 15≤V3≤40.

Embodiment 4. The lens group according to Embodiment 1, where the fourth group is a fifth lens, a curvature radius of an object side surface of the fifth lens is R51, a curvature radius of an image side surface of the fifth lens is R52, and R51 and R52 meet:

|f/R51|+|f/R52|≤8.

Embodiment 5. The lens group according to Embodiment 1, where a combined focal length of the second lens and the third lens is f23, and f23 meets:

0≤f23/f≤3.

Embodiment 6. The lens group according to Embodiment 1, where a spacing from a center position of an image side surface of the third group to a center position of an object side surface of the fourth group is SP4, a spacing from a center position of an object side surface of the first group to a center position of an image side surface of the fourth group is LT, and SP4 and LT meet:

SP4/LT≤0.3.

Embodiment 7. The lens group according to Embodiment 1, where an off-axis chromatic aberration of the lens group is CA1, an axial chromatic aberration of the lens group is CA2, CA1 meets: CA1≤1 μm, and CA2 meets: CA2≤10 μm.

Embodiment 8. The lens group according to Embodiment 1, where a length of the lens group is L_1, a length from a center of gravity of the lens group to a vertex position of an image side surface of the first group is L_2, and L_1 and L_2 meet:

0.4×L_1≤L_2≤0.6×L_1.

Embodiment 9. The lens group according to Embodiment 1, where the first group is a first lens, the third group is a fourth lens, the fourth group is a fifth lens, at least one of the first lens, the second lens, the third lens, the fourth lens, and the fifth lens is made of glass, a relative refractive index temperature coefficient of the at least one lens is β, and β meets:

−9×10⁻⁵≤β≤9×10⁻⁵.

Embodiment 10. The lens group according to Embodiment 9, where the second lens and the third lens are made of glass.

Embodiment 11. The lens group according to any one of Embodiments 1 to 10, where a bonding surface of the second lens and the third lens is a spherical surface, a curvature radius of the bonding surface is R23, and R23 meets:

0 mm≤R23≤10 mm.

Embodiment 12. The lens group according to Embodiment 1, where a temperature drift coefficient of the lens group is Δf/Δ° C., and Δf/Δ° C. meets:

−0.5 μm/° C.≤Δf/Δ° C.≤1.5 μm/° C.

Embodiment 13. The lens group according to Embodiment 1, where the lens group further includes a stop; and the stop is located on a side that is of the first group and that faces the image side, or the stop is located on a side that is of the first group and that faces the object side.

Embodiment 14. The lens group according to Embodiment 1, where an object side surface of the first lens is a convex surface at a paraxial position.

Embodiment 15. A camera module, including an image sensor, where the camera module further includes the lens group according to any one of Embodiments 1 to 14, and the image sensor is located on an image side of the lens group.

Embodiment 16. The lens group according to Embodiment 15, where an infrared cut-off filter is disposed on a side that is of the fourth group and that faces the image side.

Embodiment 17. A terminal device, including the camera module according to Embodiment 15 or 16.

Embodiment 18. A mobile phone, including:

a housing;

a display;

a speaker;

a microphone; and

one or more camera modules according to Embodiment 15 or 16, where at least one lens group is located on a surface on which the display is located, or/and at least one lens group is located on a surface that faces away from the display.

1. A lens group, comprising a first group, a second group, a third group, and a fourth group that are sequentially disposed from an object side to an image side along an optical axis, wherein:
the first group has positive optical power;
the second group has positive optical power, the second group comprises a second lens and a third lens that are sequentially disposed from the object side to the image side along the optical axis, and the second lens and the third lens are bonded as a doublet;
the third group has negative optical power; and
an optical length of the lens group is TTL (Through the Lens), an effective focal length of the lens group is f, and TTL and f meet:
TTL/f≤1.

2. The lens group according to claim 1, wherein dispersion coefficients of the second lens and the third lens are respectively V2 and V3, wherein V2 meets: 15≤V2≤100, and V3 meets: 15≤V3≤100.

3. The lens group according to claim 2, wherein:
V2 and V3 meet: 15≤V2≤40, and 40≤V3≤100; or
V2 and V3 meet: 40≤V2≤100 and 15≤V3≤40.

4. The lens group according to claim 1, wherein:
the fourth group is a fifth lens,
a curvature radius of an object side surface of the fifth lens is R51,
a curvature radius of an image side surface of the fifth lens is R52, and
R51 and R52 meet:

|f/R51|+|f/R52|≤8.

5. The lens group according to claim 1, wherein a combined focal length of the second lens and the third lens is f23, and f23 meets:
0≤f23/f≤3.

6. The lens group according to claim 1, wherein a spacing from a center position of an image side surface of the third group to a center position of an object side surface of the fourth group is SP4, a spacing from a center position of an object side surface of the first group to a center position of an image side surface of the fourth group is LT, and SP4 and LT meet:
SP4/LT≤0.3.

7. The lens group according to claim 1, wherein an off-axis chromatic aberration of the lens group is CA1, an axial chromatic aberration of the lens group is CA2, CA1 meets: CA1≤1 μm, and CA2 meets: CA2≤10 μm.

8. The lens group according to claim 1, wherein a length of the lens group is L_1, a length from a center of gravity of the lens group to a vertex position of an image side surface of the first group is L_2, and L_1 and L_2 meet:
0.4×L_1≤L_2≤0.6×L_1.

9. The lens group according to claim 1, wherein the first group is a first lens, the third group is a fourth lens, the fourth group is a fifth lens, at least one of the first lens, the second lens, the third lens, the fourth lens, and the fifth lens is made of glass, a relative refractive index temperature coefficient of the at least one lens is β, and β meets:
−9×10⁻⁵≤β≤9×10⁻⁵.

10. The lens group according to claim 9, wherein the second lens and the third lens are made of glass.

11. The lens group according to claim 1, wherein a bonding surface of the second lens and the third lens is a spherical surface, a curvature radius of the bonding surface is R23, and R23 meets:
0 mm≤R23≤10 mm.

12. The lens group according to claim 1, wherein a temperature drift coefficient of the lens group is Δf/Δ° C., and Δf/Δ° C. meets:
−0.5 μm/° C.≤Δf/Δ° C.≤1.5 μm/° C.

13. The lens group according to claim 1, wherein:
the lens group further comprises a stop; and
the stop is located on a side that is of the first group and that faces the image side, or the stop is located on a side that is of the first group and that faces the object side.

14. The lens group according to claim 1, wherein an object side surface of the first lens is a convex surface at a paraxial position.

15. A camera module, comprising an image sensor, wherein the camera module further comprises the lens group, the lens group comprises a first group, a second group, a third group, and a fourth group that are sequentially disposed from an object side to an image side along an optical axis, wherein
the first group has positive optical power;
the second group has positive optical power, the second group comprises a second lens and a third lens that are sequentially disposed from the object side to the image side along the optical axis, and the second lens and the third lens are bonded as a doublet;
the third group has negative optical power; and
an optical length of the lens group is TTL (Through the Lens), an effective focal length of the lens group is f, and TTL and f meet:
TTL/f≤1; and
the image sensor is located on an image side of the lens group.

16. The camera module according to claim 15, wherein an infrared cut-off filter is disposed on a side that is of the fourth group and that faces the image side.

17. A terminal device, comprising a camera module
wherein the camera module comprises an image sensor, wherein the camera module further comprises the lens group, the lens group comprises a first group, a second group, a third group, and a fourth group that are sequentially disposed from an object side to an image side along an optical axis, wherein
the first group has positive optical power;
the second group has positive optical power, the second group comprises a second lens and a third lens that are sequentially disposed from the object side to the image side along the optical axis, and the second lens and the third lens are bonded as a doublet;
the third group has negative optical power; and
an optical length of the lens group is TTL (Through the Lens), an effective focal length of the lens group is f, and TTL and f meet:
TTL/f1; and
the image sensor is located on an image side of the lens group.

18. (canceled)
